(19) United States
(12) Patent Application Publication
(10) Pub. No.: US 2015/0176835 A1
(43) Pub. Date: Jun. 25, 2015

(54) Table tealight holder

(71) Applicants: Andrzej WRÓBEL, Wielun (PL); Adam CHUDECKI, Makrsko (PL); Roman KOTALA, Wielun (PL); Piotr CIESLAK, Wielun (PL); Tomasz WRÓBEL, Wielun (PL); Jaroslaw WOLOWIEC, Wierzchias (PL)

(72) Inventors: Andrzej WRÓBEL, Wielun (PL); Adam CHUDECKI, Makrsko (PL); Roman KOTALA, Wielun (PL); Piotr CIESLAK, Wielun (PL); Tomasz WRÓBEL, Wielun (PL); Jaroslaw WOLOWIEC, Wierzchias (PL)

(21) Appl. No.: 13/153,048

(22) Filed: Jun. 3, 2011

(51) Int. Cl. F21V 35/00

(52) U.S. Cl. CPC F21V 35/00

(57) ABSTRACT

The table cup-shaped tealight holder according to the invention has the bottom (1) inclined towards the horizontal plane at the angle (C) with the recess (2) located in the central point. There are grooves (3) in the bottom which are connected with the recess (2) and form the angle (B) with the horizontal plane.

### BACKGROUND

The object of the invention is a table tealight holder.

There are known table tealight holders with a special construction of the bottom. These holders have special forming at the bottom edge which enables to pile up the holders as in the Community Design No 000364039. There are also known table tealight holders with a bottom convex towards the inner part of the holder as in the Community Design No 000344015 which drains the excess liquid paraffin to the groove along the bottom circumference.

In these holders part of the liquid paraffin remains not used, which with large production of table tealight holders results in a substantial loss.

### SUMMARY

The table cup-shaped tealight holder with a groove-shaped forming along the bottom edge, according to the invention, has the bottom with a recess in the centre which is connected with the grooves and the angle formed by the lower groove edge and the horizontal line and the angle between the bottom plane and the horizontal plane ranges from 0 to 60 degrees.

The table tealight holder, according to the invention, allows the liquid paraffin collected at the bottom of the holder in the last burning phase to be used to a larger extent than it has been used so far.

### BRIEF DESCRIPTION OF THE DRAWINGS

An example of the object of the invention is shown in a drawing, in which:

FIG. 1 shows a general view of the table tealight holder as seen from the bottom.

FIG. 2 shows a section along the A-A line of FIG. 1.

### DETAILED DESCRIPTION

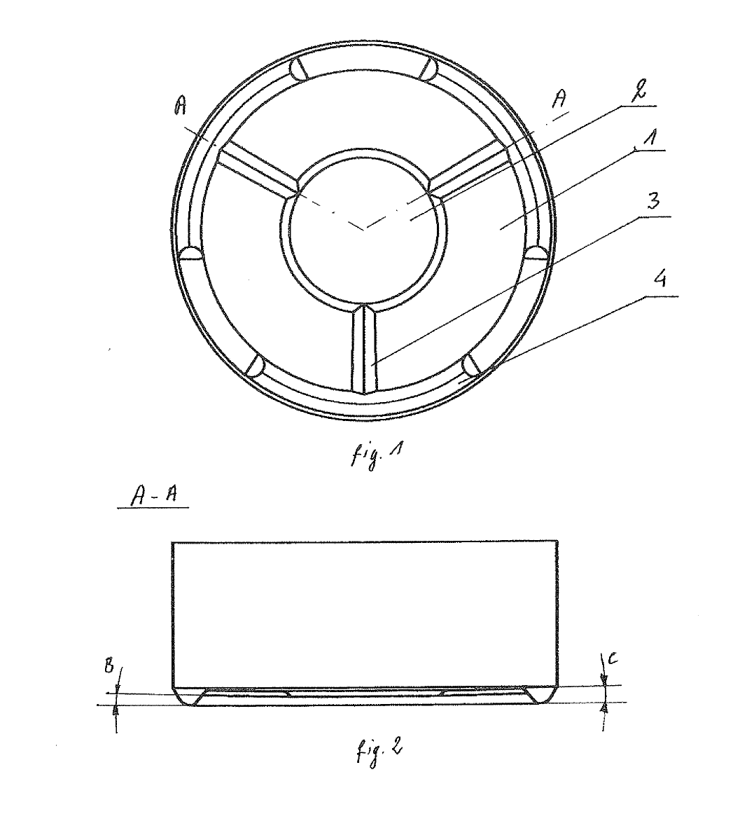

The object of the invention as a manufacturing example is presented in the drawing in which FIG. 1 shows the general view as seen from the bottom and FIG. 2 shows the section along the A-A line.

The table cup-shaped tealight holder has a groove-shaped forming 4 along the external bottom edge. In the central point the bottom j_{—} of the holder formed in the shape of a conical plane the generating angle of which is 1 degree to the horizontal plane has a flat recess 2 in which there is usually a bottom part of a wick. The grooves 3 go down to the recess 2 and connect the recess 2 with the groove 4. The grooves 3 are inclined at the angle of 1 degree towards the bottom surface, which makes the liquid paraffin flow freely to the recess 2 in the final burning process.

We claim:

1. The table cup-shaped tealight holder which has a groove-shaped forming along the bottom edge is distinguished by the fact that the bottom (1) of the holder has a recess (2) in its central point which is connected with the grooves (3) and the angle (B) between the lower groove (3) edge and the horizontal line as well as the angle (C) between the bottom plane and the horizontal plane ranges from 0 to 60 degrees.
